(19) United States
(12) Patent Application Publication
(10) Pub. No.: US 2014/0195371 A1
(43) Pub. Date: Jul. 10, 2014

(54) INFORMATION PROCESSING APPARATUS, INFORMATION PROCESSING METHOD, PROGRAM AND TERMINAL APPARATUS

(71) Applicant: SONY CORPORATION, Tokyo (JP)

(72) Inventors: Yuichi KAGEYAMA, Tokyo (JP); Mitsuru TAKEHARA, Tokyo (JP); Hisahiro SUGANUMA, Tokyo (JP); Yoshiki TANAKA, Kanagawa (JP)

(73) Assignee: SONY CORPORATION, Tokyo (JP)

(21) Appl. No.: 14/132,142

(22) Filed: Dec. 18, 2013

(30) Foreign Application Priority Data
Jan. 9, 2013 (JP) 2013-001874

(51) Int. Cl. G06Q 30/06; G06Q 50/00

(52) U.S. Cl. CPC G06Q 30/0631; G06Q 50/01
USPC 705/26.7

(57) ABSTRACT

There is provided an information processing apparatus including a recommendation unit configured to generate a recommendation information for a target user based on a preference information of at least one associated person having a social relationship through a communication service or a locational relationship with the target user, and a communication interface configured to provide the generated recommendation information to be sent to the target user.

### CROSS REFERENCE TO RELATED APPLICATIONS

This application claims the benefit of Japanese Priority Patent Application JP 2013-001874 filed Jan. 9, 2013, the entire contents of which are incorporated herein by reference.

### BACKGROUND

The present disclosure relates to an information processing apparatus, an information processing method, a program and a terminal apparatus.

In recent years, a variety of services through a network such as the Internet has been provided to users. For example, a social networking service (SNS) provides an occasion of communications among users through a network. A location-aware service provides diverse information that is associated with the current locations of users. Furthermore, many users utilize online stores to purchase products online.

Many online stores are provided with a scheme that recommends products to users. For example, if a user browses the detail information of a certain product, the information about products associated with the product is presented to the user as recommended products. Generally, a scheme for the recommendation is implemented by using some sort of recommendation algorithm, as typified by a collaborative filtering and content-based filtering that are described in Japanese Patent Laid-Open No. 2012-190061. The collaborative filtering is an algorithm based on the preference of a user, and determines a recommendation score using the information relevant to actions (for example, a purchasing, a viewing and listening, or a browsing) of other users who are similar in preference. The content-based filtering is an algorithm based on the attribute of an item such as a product, and determines a recommendation score based on the attribute of an item that is the object of an action of a user. Typically, items with high recommendation scores are selected as recommendation items to be presented to the user. Japanese Patent Laid-Open No. 2012-190061, in order to achieve an effective recommendation, proposes dynamically combining such two kinds of recommendation algorithms in response to a user's situation.

### SUMMARY

However, in the existing recommendation methods, there is not reflected the factor of word-of-mouth communication, which strongly affects the action of a user. Generally, word-of-mouth information is the information from other users who may or may not have any interest in sellers trying to sell items, and is one of important information for the user to determine his or her action such as a purchasing and a viewing and listening. However, it is troublesome for the user to actively collect word-of-mouth information. Furthermore, from a viewpoint of privacy protection, it is undesirable that the service side automatically collect pure word-of-mouth information, and distribute it among users.

Hence, it is desirable to implement a novel recommendation scheme that incorporates therein the factor of word-of-mouth communication and can resolve or reduce the above-described disadvantages.

According to an embodiment of the present disclosure, there is provided an information processing apparatus including: a recommendation unit configured to generate a recommendation information for a target user based on a preference information of at least one associated person having a social relationship through a communication service or a locational relationship with the target user; and a communication interface configured to provide the generated recommendation information to be sent to the target user.

According to another embodiment of the present disclosure, there is provided an information processing method including: generating a recommendation information for a target user based on a preference information of at least one associated person having a social relationship through a communication service or a locational relationship with the target user; and providing the generated recommendation information to be sent to the target user.

According to another embodiment of the present disclosure, there is provided a terminal apparatus forming part of a communication system, the communication system also including an information processing apparatus configured to provide recommendation information to the terminal apparatus, the terminal apparatus including: a circuitry configured to transmit and receive data signals via a network; send a request for recommendation information for a user of the terminal apparatus; and receive the recommendation information which is generated based on a preference information of at least one associated person having a social relationship though a communication service or a locational relationship with the user of the terminal apparatus.

According to another embodiment of the present disclosure, there is provided a method including: requesting a recommendation information for a target user from a server; and receiving the recommendation information from the server, wherein the recommendation information is generated based on a preference information of at least one associated person having a social relationship through a communication service or a locational relationship with the target user.

By the technology according to the present disclosure, it is possible to implement an effective recommendation scheme that incorporates therein the factor of word-of-mouth communication.

### BRIEF DESCRIPTION OF THE DRAWINGS

FIG. 1 is an explanatory diagram for explaining an outline of a recommendation system;

FIG. 2 is a block diagram showing an exemplary hardware configuration of a server apparatus according to embodiments;

FIG. 3 is a block diagram showing an exemplary logically-functional configuration of a server apparatus according to embodiments;

FIG. 4 is an explanatory diagram for explaining a first example of a method for determining the weight of each associated user;

FIG. 5 is an explanatory diagram for explaining a second example of a method for determining the weight of each associated user;

FIG. 6 is an explanatory diagram for explaining an exemplary relation of a basic recommendation score, a correction recommendation score and an after-correction recommendation score;

FIG. 7 is a flowchart showing an exemplary flow of a recommendation process that is executed by a server apparatus according to embodiments;

FIG. 8 is a block diagram showing an exemplary hardware configuration of a terminal apparatus according to embodiments;

FIG. 9 is a block diagram showing an exemplary logically-functional configuration of a terminal apparatus according to embodiments;

FIG. 10 is an explanatory diagram for explaining a switching of recommendation scores;

FIG. 11A is the anterior half of a sequence diagram for explaining a first example of a recommendation scenario;

FIG. 11B is the latter half of the sequence diagram for explaining the first example of the recommendation scenario;

FIG. 12A is the anterior half of a sequence diagram for explaining a second example of a recommendation scenario; and

FIG. 12B is the latter half of the sequence diagram for explaining the second example of the recommendation scenario.

### DETAILED DESCRIPTION OF EMBODIMENT(S)

Hereinafter, embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Descriptions will be given in the following order.

1. Outline of system
2. Configuration of server apparatus

2-1. Exemplary hardware configuration

2-2. Exemplary functional configuration

2-3. Exemplary process flow

3. Configuration of terminal apparatus

3-1. Exemplary hardware configuration

3-2. Exemplary functional configuration

3-3. Modifications

4. Exemplary recommendation scenario

4-1. First scenario

4-2. Second scenario

### 5. Conclusion

### 1. Outline of System

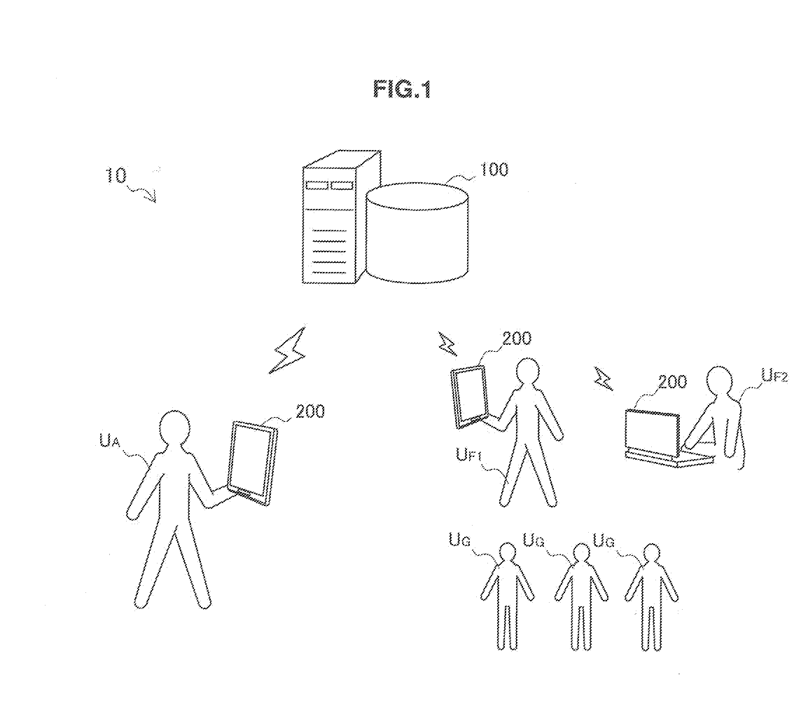

First, an outline of a recommendation system according to embodiments will be described using FIG. 1. With reference to FIG. 1, a recommendation system 10 is shown as an example. The recommendation system 10 includes a server apparatus 100 and terminal apparatuses 200.

The server apparatus 100 is an information processing apparatus that provides a recommendation function for recommending an appropriate item to a user. The server apparatus 100 is connected with the terminal apparatuses 200 through a network such as the Internet or a virtual private network (VPN). The item to be recommended by the server apparatus 100 may be any kind of items, such as a product to be sold at an online store, a video, picture or music content to be delivered through the network, advertising information, or a news article. The server apparatus 100 sends a recommendation result, in response to a recommendation request from an apparatus such as the terminal apparatus 200, or an application server, which is not shown in the figure.

The recommendation result to be generated by the server apparatus 100, typically, can contain a list of items whose recommendation scores, which are determined in a recommendation process, are high, or a list of the items and the recommendation scores. In embodiments, the server apparatus 100 determines a base score of the recommendation score (hereinafter, referred to as a basic recommendation score), in accordance with a known recommendation algorithm, which can include a collaborative filtering, a content-based filtering or a combination thereof. Then, the server apparatus 100 corrects the basic recommendation score using a correction recommendation score, and thereby generates an after-correction recommendation score. As described in detail later, the factor of word-of-mouth communication is incorporated in the correction recommendation score.

The terminal apparatus 200 is an information processing apparatus that is utilized by a user. The terminal apparatus 200 may be an information processing terminal such as a personal computer (PC), a smart phone, a personal digital assistant (PDA), a navigation apparatus or a game terminal, or may be a digital household electric appliance such as a television apparatus. The terminal apparatus 200 is not limited to the example of FIG. 1, and may be a wearable apparatus such as a head mounted display (HMD).

In the example of FIG. 1, the user U_{A} is a target user who is a target of the recommendation. The terminal apparatus 200 that the user U_{A} is having, receives the recommendation result generated for the user U_{A} by the server apparatus 100, and displays the received recommendation result on the screen. The user U_{F1} and user U_{F2} are persons who have an association with the user U_{A}. In the specification, a user who has an association with a target user is referred to as an associated user. The correction recommendation score used by the server apparatus 100 is determined based on an action of the associated user. In FIG. 1, two users, the user U_{F1} and user U_{F2} are shown as associated users. However, the number of associated users is not limited to this example, and may be more or may be less. The users U_{G} are users who are not associated users. The preferences and action histories of the user U_{G} can be referred to by the server apparatus 100, in determination of the basic recommendation score.

### 2. Configuration of Server Apparatus

In this section, an exemplary configuration of the server apparatus 100 shown in FIG. 1 will be described.

[2-1. Exemplary Hardware Configuration]

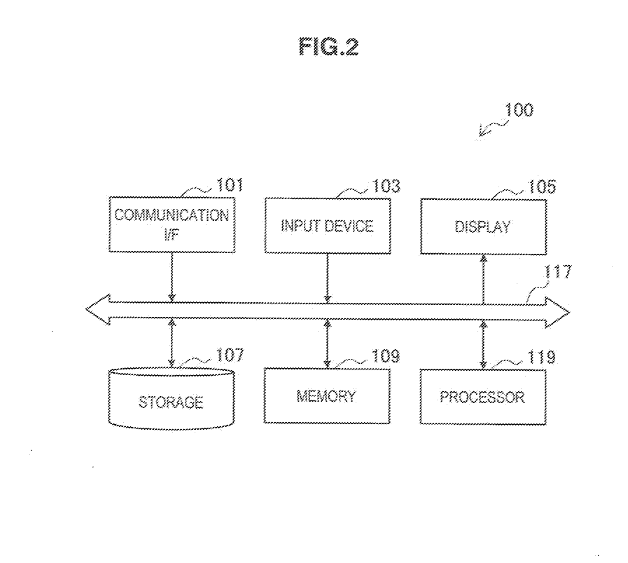

FIG. 2 is a block diagram showing an exemplary hardware configuration of a server apparatus 100 according to embodiments. With reference to FIG. 2, the server apparatus 100 includes a communication interface (I/F) 101, an input device 103, a display 105, a storage 107, a memory 109, a bus 117, and a processor 119.

The communication I/F 101 is a communication interface that supports an arbitrary wireless communication protocol or wire communication protocol. The communication I/F 101 establishes a communication connection between the server apparatus 100 and the terminal apparatus 200. The input device 103 is a device through which an operator of the server apparatus 100 operates the server apparatus 100. The input device 103 can include a keyboard and a pointing device, for example. The display 105 includes a screen constituted by a liquid crystal display (LCD), an organic light-emitting diode (OLED) or a cathode ray tube (CRT), for example. The storage 107 is constituted by, for example, a high-capacity storage medium such as a hard disk, and stores various data that are within a database in the server apparatus 100. The memory 109 may be a semiconductor memory that can include a random access memory (RAM) and a read only memory (ROM), and stores programs and data for processing by the server apparatus 100. The bus 117 mutually connects the communication I/F 101, the input device 103, the display 105, the storage 107, the memory 109 and the processor 119. The processor 119 may be a central processing unit (CPU) or a digital signal processor (DSP), for example. The processor 119 executes the programs stored in the memory 109 or other storage media, and thereby activates various functions of the server apparatus 100, which will be described later.

[2-2. Exemplary Functional Configuration]

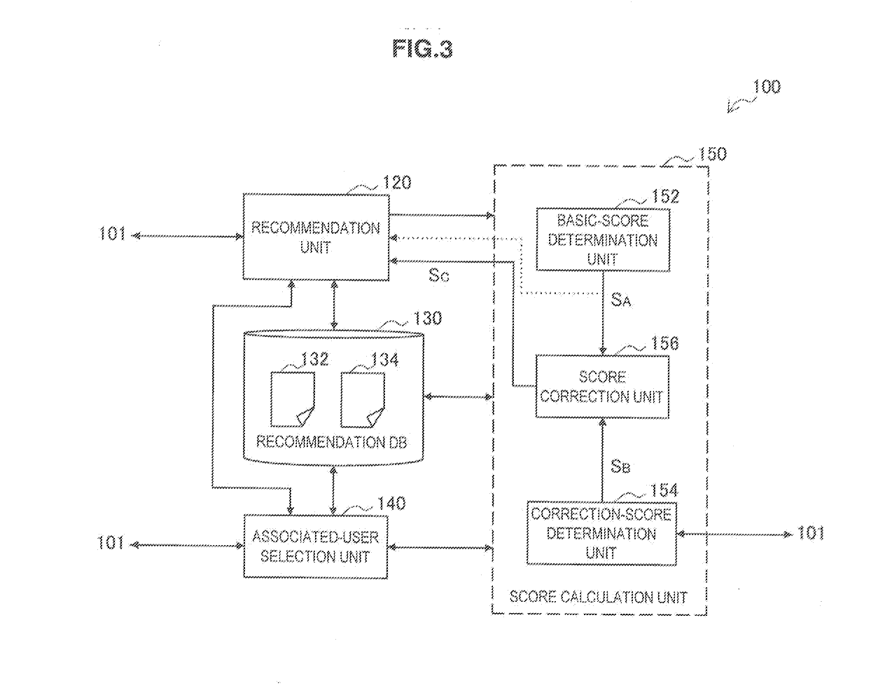

FIG. 3 is a block diagram showing an exemplary configuration of logical functions that are implemented in the storage 107, memory 109 and processor 119 of the server apparatus 100 shown in FIG. 2. With reference to FIG. 3, the server apparatus 100 includes a recommendation unit 120, a recommendation DB 130, an associated-user selection unit 140, and a score calculation unit 150. The score calculation unit 150 includes a basic-score determination unit 152, a correction-score determination unit 154, and a score correction unit 156.

(1) Recommendation Unit

The recommendation unit 120 controls the execution of the recommendation process in the server apparatus 100. For example, once receiving a recommendation request from the terminal apparatus 200 through the communication I/F 101, the recommendation unit 120 starts an execution of the recommendation process. In the recommendation process, the recommendation unit 120 identifies the target user, for example, using a user ID contained in the recommendation request, and makes the associated-user selection unit 140 select associated users who have an association with the target user. Furthermore, the recommendation unit 120 makes the basic-score determination unit 152 and correction-score determination unit 154 determine a basic recommendation score S_{A} and correction recommendation score S_{B} for the target user, respectively. Next, the recommendation unit 120 makes the score correction unit 156 correct the basic recommendation score S_{A} using the correction recommendation score S_{B} and generate an after-correction recommendation score S_{C}. Then, the recommendation unit 120 selects a recommended item based on the generated after-correction recommendation score S_{C}, and sends, as a recommendation result, the information relevant to the recommended item to the terminal apparatus 200 through the communication I/F 101.

For example, the recommendation unit 120 may update the recommendation score at fixed intervals, and periodically send the new recommendation result to the terminal apparatus 200 of the target user. Alternatively, the recommendation unit 120 may update the recommendation score whenever a predetermined event is detected, and send the new recommendation result. Examples of the predetermined event can include a receipt of a recommendation update request, a change in the communication situation of the target user, a movement of the user, a new action of an associated user, or an increase or decrease in associated users.

(2) Recommendation Database

The recommendation DB 130 is a database in which various data to be used in the recommendation process are stored. In the example of FIG. 3, the recommendation DB 130 contains user data 132 and item data 134.

The user data 132 can contain a user ID, a nickname, attribute data (for example, age and sex), preference data (for example, categories of favorite items), position data, and communication situation data, for each of users who are registered in the recommendation system 10. The position data and communication situation data of users can be received from the individual terminal apparatuses 200, and stored in the recommendation DB 130. The item data 134 can contain an item ID, a name and attribute data (for example, categories), for each of the many items that are objects to be recommended. The data described here are just examples. That is, other types of data may be stored in the recommendation DB 130, and some of the above-described data may be omitted.

(3) Associated-User Selection Unit

The associated-user selection unit 140 selects one or more associated users who have an association with the target user, for determining the correction recommendation score. As a first criterion, the associated-user selection unit 140 may select users who are at the neighborhood of the target user as associated users. As a second criterion, the associated-user selection unit 140 may select associated users, based on the communication situation of the target user in a social network. As a third criterion, the associated-user selection unit 140 may select associated users, based on a recognition processing of a picture or voice acquired through an apparatus (for example, a camera or microphone mounted on the terminal apparatus 200) that the target user carries or wears. As a fourth criterion, the associated-user selection unit 140 may select, as associated users, users whom the target user designates through a user interface.

In the first criterion, the associated-user selection unit 140 may recognize users who are at the neighborhood of the target user, that is, associated users, based on position data that are collected from the terminal apparatuses 200 of the target user and other users. If the terminal apparatus 200 has a neighborhood-terminal detection function (for example, Wi-Fi Direct), the associated-user selection unit 140 may recognize, as associated users, users with neighborhood terminals that are detected by the terminal apparatus 200 of the target user. According to the first criterion, it is possible to incorporate in the recommendation score the factor of word-of-mouth communication from other users with whom the target user acts together in the real world, or other users who are in the place where the target user is visiting. Here, users (for example, family members of the target user) who are at the neighborhood of the target user for long periods may be excluded from associated users. Thereby, it is possible to avoid a loss of freshness of the recommendation result, caused by a continuous presentation of similar recommended items.

In the second criterion, the associated-user selection unit 140 may recognize, as associated users, users who are judged as having a high degree of intimacy with the target user, based on communication situation data that are collected from the terminal apparatus 200 of the target user. For example, users who frequently exchange messages with the target user can be judged as having a high degree of intimacy with the target user. Also, users who belong to the same community as the target user can be judged as having a high degree of intimacy with the target user. For example, the communication situation data can be generated from logs of an SNS or another service involving a social network in the terminal apparatus 200, and collected by the associated-user selection unit 140. According to the second criterion, it is possible to incorporate in the recommendation score the factor of word-of-mouth communication from other users in whom the target user is interested in the real world, or other users who are intimate with the target user. Here, the degree of intimacy between users may be regulated, by analyzing the contents of messages exchanged between the users using a natural language analysis technique. Thereby, it is possible to more accurately judge the degree of intimacy and select more appropriate associated users. The degree of intimacy is not limited to the above-described examples, and may be judged using a social graph that is acquired from an SNS.

In the third criterion, the associated-user selection unit 140 may recognize associated users, by applying a known personal recognition technique to a picture or voice that is acquired from the terminal apparatus 200 of the target user. In this case, the user data 132 stored in the recommendation DB 130 can contain face-picture data for individual users that are compared with the picture, or speech-feature data for individual users that are compared with the voice. According to the third criterion, it is possible to incorporate in the recommendation score the factor of word-of-mouth communication from other users with whom the target user acts or talks together in the real world, or other users in whom the target user is interested.

In the fourth criterion, the associated-user selection unit 140 may display a graphical user interface (GUI) for designating associated users on the screen of the terminal apparatus 200, and acquire the user IDs of one or more associated users through the displayed GUI. For example, associated users may be designated from a friend user list of the target user that is registered in an SNS. Alternatively, associated users may be designated from a list of associated user candidates that are extracted in accordance with the above-described first criterion, second criterion or third criterion. According to the fourth criterion, it is possible to select, as associated users, users from whom the target user wants to incorporate in the recommendation score the factor of word-of-mouth communication.

The above-described criteria for selecting associated users may be combined in any combination. Also, another selection criterion may be used. Furthermore, the associated-user selection unit 140 may provide, to the terminal apparatus 200, a GUI through which the target user designates a selection criterion in selection of associated users. For example, the associated-user selection unit 140 may display a list of the selection criteria on the screen of the terminal apparatus 200, and select associated users in accordance with the selection criterion designated by the target user. Thereby, it is possible to incorporate the factor of word-of-mouth communication, furthermore flexibly change the recommendation result in response to an intention of the user.

The associated-user selection unit 140 outputs a user ID list of associated users selected in this way, to the correction-score determination unit 154.

(4) Basic-Score Determination Unit

The basic-score determination unit 152 determines the basic recommendation score S_{A} for the target user. The basic recommendation score S_{A} can be determined by the basic-score determination unit 152, in accordance with a known recommendation algorithm, which can include the collaborative filtering, the content-based filtering or a combination thereof. For example, in the case of using the collaborative filtering, the basic-score determination unit 152 compares preference data contained in the user data 132 between the target user and other users, and adds a score to items that are the objects of the past actions of other users having a similar preference to the target user. The in-question other users can include also many users U_{G} who are not associated users. In the case of using the content-based filtering, the basic-score determination unit 152 adds a score to items with a similar item attribute to an item that is the object of an action of the target user. Since details of the collaborative filtering and content-based filtering are known to those in the art, additional description is omitted here. The basic-score determination unit 152 may determine the basic recommendation score S_{A}, in accordance with a recommendation algorithm different from the collaborative filtering and the content-based filtering. The basic-score determination unit 152 outputs the determined basic recommendation score S_{A} to the score correction unit 156 and the recommendation unit 120.

(5) Correction-Score Determination Unit

The correction-score determination unit 154 determines the correction recommendation score S_{B}, based on actions of the associated users selected by the associated-user selection unit 140. In embodiments, the correction-score determination unit 154 calculates the correction recommendation score S_{B}, using the weight of each associated user and the rating value that is acquired for each associated user. Typically, the sum of the weights of all the associated users is 1.

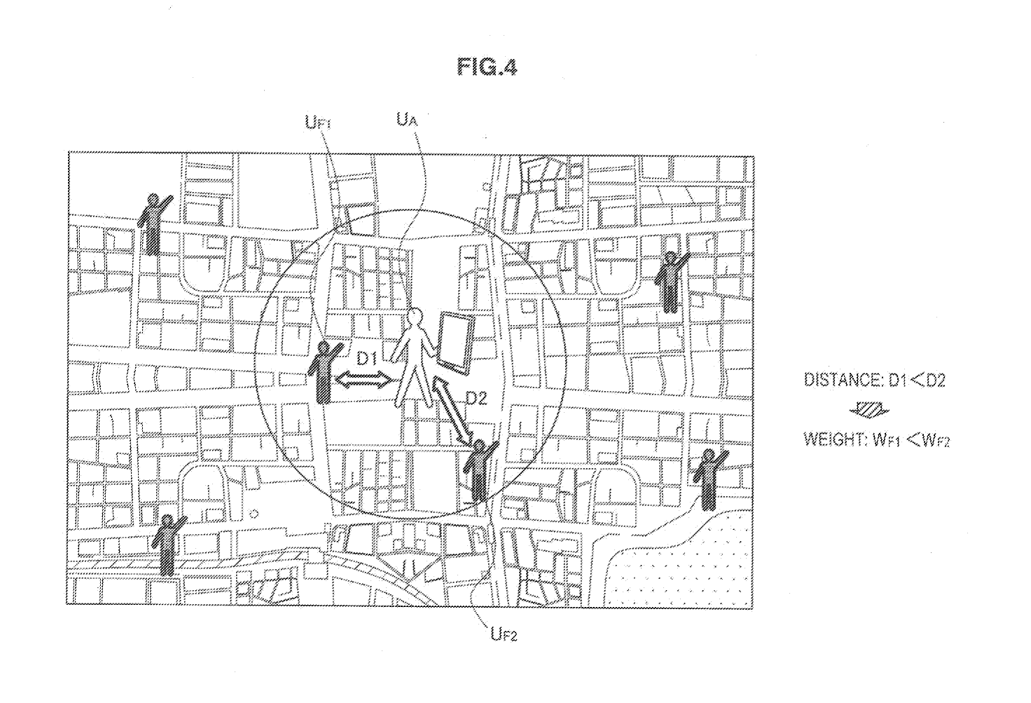

For example, the correction-score determination unit 154 may determine the weight of each associated user, based on the position data of the target user. FIG. 4 is an explanatory diagram for explaining a first example of a method for determining the weight of each associated user. With reference to FIG. 4, the current position of the target user U_{A} is shown at the center of a map in the real world. The user U_{F1} and user U_{F2} who are within the circle centered at the current position of the target user U_{A}, are associated users selected by the associated-user selection unit 140. The distance D1 is a distance between the target user U_{A} and the associated user U_{F1}. The distance D2 is a distance between the target user U_{A} and the associated user U_{F2}. The distance D2 is greater than the distance D2. In this case, the correction-score determination unit 154 can determine the weight W_{F1} of the associated user U_{F1} so as to be greater than the weight W_{F2} of the associated user U_{F2}.

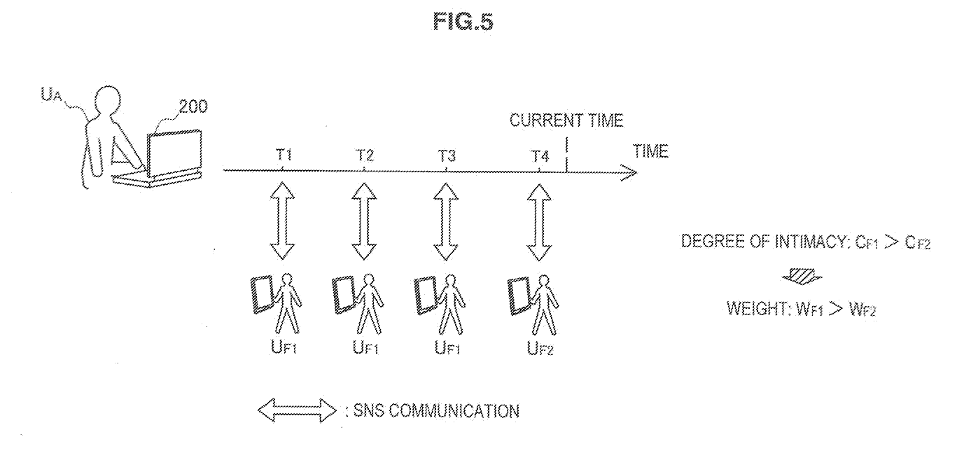

In addition, for example, the correction-score determination unit 154 may determine the weight of each associated user, based on the communication situation of the target user. FIG. 5 is an explanatory diagram for explaining a second example of a method for determining the weight of each associated user. With reference to FIG. 5, a communication history of the target user U_{A} in an SNS is shown along the time axis. For example, the target user U_{A} exchanges messages with the user U_{F1} at times T1, T2 and T3. Also, the target user U_{A} exchanges messages with the user U_{F2} at time T4. These user U_{F1} and user U_{F2} can be selected as associated users by the associated-user selection unit 140. For example, the degree of intimacy C_{F1} of the associated user U_{F1} who has a higher frequency of communication with the target user U_{A}, can be judged as being higher than the degree of intimacy C_{F2} of the associated user U_{F2} who has a lower frequency of communication. Therefore, the correction-score determination unit 154 may determine the weight W_{F1} of the associated user U_{F1} so as to be greater than the weight W_{F2} of the associated user U_{F2}. Alternatively, the correction-score determination unit 154 may determine the weight W_{F2} of the associated user U_{F2} who communicated with the target user U_{A} at time T4, which is a time nearer to the current time, so as to be greater than the weight W_{F1} of the associated user U_{F1}.

Furthermore, the correction-score determination unit 154 determines the rating value of each item for each associated user. As an example, the rating value can be determined based on the action history of each of the associated users. For example, when a certain associated user views or listens to a video content or music content, the rating value of the content that was viewed or listened to increases. When a certain associated user browses or purchases a product at an online store, the rating value of the product increases. Actions of the associated users may be judged from operation logs of an application, such as an internet browser or a content player, in the terminal apparatuses 200, or may be judged from output data of a camera or sensor in the terminal apparatuses 200. The correction-score determination unit 154 may receive the action history generated in the terminal apparatus 200 and then determine the rating value based on the action history, or may receive the rating value determined in the terminal apparatus 200. In the following description, the action history or rating value received from the terminal apparatus 200 is referred to as the rating information. According to such methods, it is possible to automatically collect the rating value that can correspond to word-of-mouth information, without imposing a trouble of registering the word-of-mouth information on the associated users.

The correction-score determination unit 154 may attenuate the rating value determined based on the action history of each of the associated users, with time. In this case, the rating value of an item that was purchased, was viewed or listened to, or was browsed by an associated user, increases immediately after the action, and gradually decreases with time. The rating value may be attenuated with time in a linear manner or in a curved manner (for example, a Kaplan-Meier curve or a logistic curve). According to such methods, it is possible to adapt the correction recommendation score for a change in actions of the associated users, and successively update the recommendation result that reflects the factor of word-of-mouth communication.

As another example, the correction-score determination unit 154 may acquire the rating value that is explicitly designated by each of the associated users, as the rating information from the terminal apparatus 200. In this case, the correction-score determination unit 154 provides a GUI through which the associated users designate the rating value for each item, to the terminal apparatus 200 of the associated users. According to such a method, it is possible to reflect explicit evaluations of individual items by the associated users in the correction recommendation score.

The correction-score determination unit 154 can calculate the correction recommendation score S_{B} for each item, by multiplying the weight and rating value determined in such a way for each item and then summing the products over all the associated users. Other than the above-described example, an equal weight may be used for all the associated users. Then, the correction-score determination unit 154 outputs the calculated correction recommendation score S_{B} to the score correction unit 156.

The correction recommendation score S_{B} may be a negative value. For example, the rating value of an item that an associated user dislikes may be determined as a negative value. Also, for example, the weight of an associated user who has a negative association with the target user (a person who is incompatible with the target user, or the like), may be determined as a negative value. The associated user who has a negative association may be explicitly designated by the target user, or may be judged by analyzing the contents of exchanged messages.

(6) Score Correction Unit

The score correction unit 156 generates the after-correction recommendation score S_{C}, by correcting the basic recommendation score S_{A} determined by the basic-score determination unit 152, using the correction recommendation score S_{B} determined by the correction-score determination unit 154. In embodiments, the score correction unit 156 adds the product of the correction recommendation score S_{B} and a synthesis ratio, to the basic recommendation score S_{A}. The synthesis ratio is a ratio of the correction recommendation score S_{B} to the basic recommendation score S_{A}.

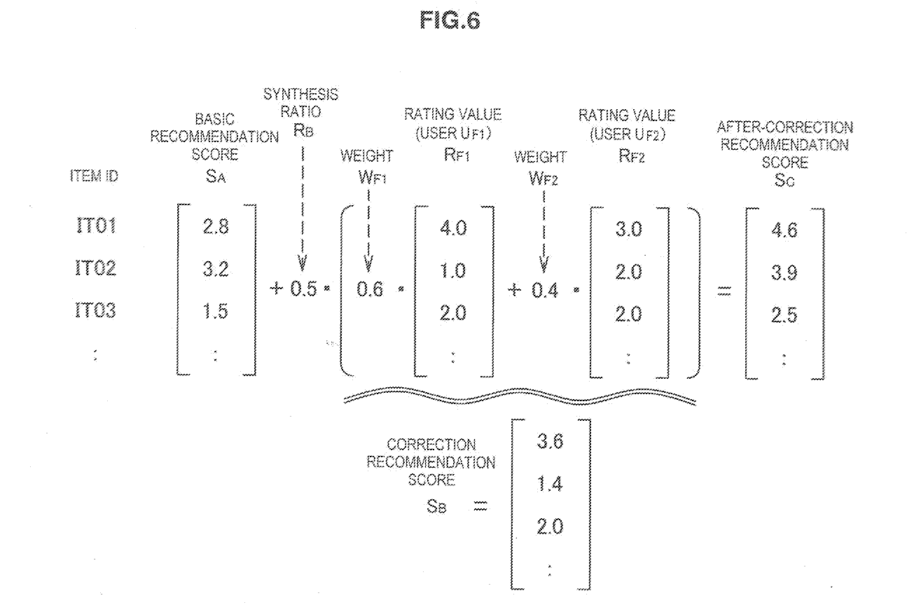

FIG. 6 is an explanatory diagram for explaining an exemplary relation of the basic recommendation score S_{A}, the correction recommendation score S_{B} and the after-correction recommendation score S_{C}. With reference to FIG. 6, there is shown a relational expression of the basic recommendation score S_{A}, the correction recommendation score S_{B} and the after-correction recommendation score S_{C}. Each of the recommendation scores is expressed in a vector form in which the score values of multiple items are included as elements. In the figure, there are exemplified three items IT01, IT02 and IT03. As an example, here, each value of the basic recommendation score S_{A} and correction recommendation score S_{B} is a numerical value in the range of 1.0 to 5.0. The value of each recommendation score is not limited to this example, and may be in any range.

The first term of the left-hand side of the relational expression corresponds to the basic recommendation score S_{A}. In the example of FIG. 6, the basic recommendation score S_{A} is S_{A}=(2.8, 3.2, 1.5, . . . )^{T}.

The second term of the left-hand side of the relational expression corresponds to the product of the correction recommendation score S_{B} and the synthesis ratio R_{B}. As described above, the correction recommendation score S_{B} is equal to the sum of the products, which result from multiplying the weight and rating value for each associated user, over all the associated users. In the example of FIG. 6, the synthesis ratio R_{B} is R_{B}=0.5. The selected associated users are a user U_{F1} and user U_{F2}, the weight W_{F1} of the associated user U_{F1} is W_{F1}=0.6, and the weight W_{F2} of the associated user U_{F2} is W_{F2}=0.4. The rating value R_{F1} for the associated user U_{F1} is R_{F1}=(4.0, 1.0, 2.0, . . . )^{T}. The rating value R_{F2} for the associated user U_{F2} is R_{F2}=(3.0, 2.0, 2.0, . . . )^{T}. From these values, the correction recommendation score S_{B} is calculated to be S_{B}=(3.6, 1.4, 2.0, . . . )^{T}.

The right-hand side of the relational expression corresponds to the after-correction recommendation score S_{C}. In the example of FIG. 6, by adding the product of the correction recommendation score S_{B} and synthesis ratio R_{B} to the basic recommendation score S_{A}, the after-correction recommendation score S_{C} is calculated to be S_{C}=(4.6, 3.9, 2.5, . . . )^{T}.

In the example of FIG. 6, if an item is recommended in accordance with the basic recommendation score S_{A}, the item IT02, which exhibits the highest recommendation score, is judged as being the most appropriate item for the target user. However, if an item is recommended in accordance with the after-correction recommendation score S_{C} that incorporates therein the factor of word-of-mouth communication, the item IT01 exhibits the highest recommendation score instead of the item IT02. Thus, according to embodiments, by incorporating the factor of word-of-mouth communication, it is possible to provide a recommendation result that is different from a recommendation result by the existing recommendation algorithms such as the collaborative filtering or the content-based filtering. In addition, in consequence of the recommendation score synthesis, the degree to which the rating value from each associated user is reflected in the after-correction recommendation score S_{C}, and the associated user's identity are not displayed to the target user in the recommendation result, and therefore the requirement of privacy protection is met.

The score correction unit 156 may variably control the synthesis ratio R_{B}. As an example, the score correction unit 156 may increase the synthesis ratio R_{B}, while the target user participates in a specific community (for example, a community that is formed in an SNS). As another example, the score correction unit 156 may increase the synthesis ratio R_{B}, while the target user is in a predefined specific place. Examples of the specific place include a place where many persons gather, such as a restaurant, a bar, a live hall, a stadium, a school, or a public hall. When a high value is set to the synthesis ratio R_{B}, the proportion of the correction recommendation score S_{B} included in the after-correction recommendation score S_{C} increases, and the factor of word-of mouse communication has a greater effect on the recommendation result. Thereby, it is possible to increase a possibility that the experience about the same item is shared among users who participate in a community, or users who gather in the same place, and to animate the communication through a recommendation of an item.

[2-3. Exemplary Process Flow]

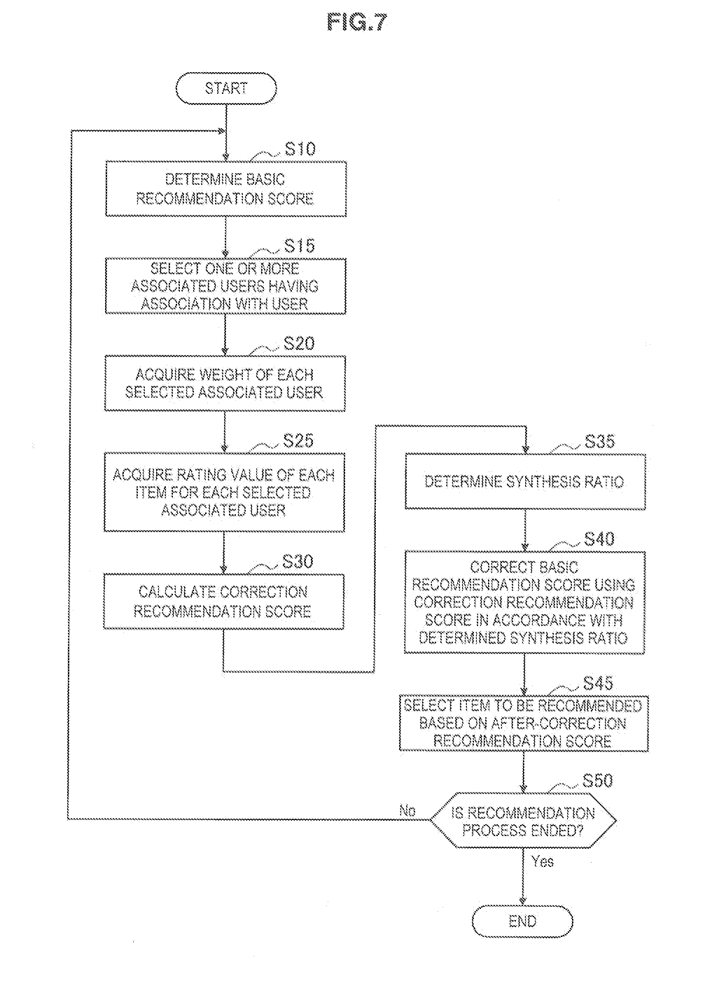

FIG. 7 is a flowchart showing an exemplary flow of a recommendation process that is executed by the server apparatus 100 according to embodiments. The recommendation process shown in FIG. 7 can start in response to a receipt of a recommendation request by the recommendation unit 120.

With reference to FIG. 7, first, the basic-score determination unit 152 determines the basic recommendation score for the target user, in accordance with a known recommendation algorithm (step S10). The associated-user selection unit 140 selects one or more associated user who have an association with the target user (step S15).

Next, the correction-score determination unit 154 acquires the weight of each of the associated users that are selected by the associated-user selection unit 140 (step S20). Also, the correction-score determination unit 154 acquires the rating value of each item for each of the selected associated users (step S25). Then, the correction-score determination unit 154 calculates the correction recommendation score for each item, by summing the products of the acquired weights and rating values over all the associated users (step S30).

Next, the score correction unit 156 determines the synthesis ratio of the correction recommendation score to the basic recommendation score (step S35). Then, the score correction unit 156 corrects the basic recommendation score in accordance with the determined synthesis ratio, using the correction recommendation score calculated by the correction-score determination unit 154 (step S40).

Next, the recommendation unit 120 selects an item to be recommended based on the after-correction recommendation score generated by the score correction unit 156, and sends the recommendation result to the terminal apparatus 200 through the communication I/F 101 (step S45).

Thereafter, the recommendation unit 120 judges whether to end the recommendation process (step S50). For example, in the case where an application for displaying the recommendation result is shut down in the terminal apparatus 200, the recommendation unit 120 ends the recommendation process. If the recommendation process is continued, the flowchart returns to step S10. The recommendation result is updated periodically, or whenever a predetermined event is detected.

### 3. Configuration of Terminal Apparatus

In this section, an exemplary configuration of the terminal apparatus 200 shown in FIG. 1 will be described.

[3-1. Exemplary Hardware Configuration]

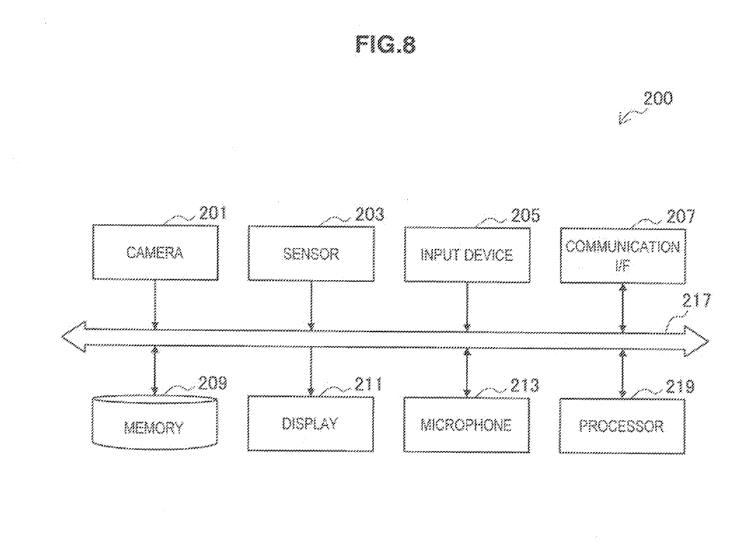

FIG. 8 is a block diagram showing an exemplary hardware configuration of a terminal apparatus 200 according to embodiments. With reference to FIG. 8, the terminal apparatus 200 includes a camera 201, a sensor 203, an input device 205, a communication I/F 207, a memory 209, a display 211, a microphone 213, a bus 217 and a processor 219.

(1) Camera

The camera 201 includes an image-pickup element such as a charge coupled device (CCD) or a complementary metal oxide semiconductor (CMOS), and generates a pickup image. For example, in order to select the associated user, the camera 201 may pick up a user who is at the neighborhood of the target user. Furthermore, in order to recognize an action of the associated user, the camera 201 may pick up the associated user.

(2) Sensor

The sensor 203, typically, is a sensor module that can include a positioning sensor. For example, the positioning sensor may be a global positioning system (GPS) sensor that receives GPS signals to measure latitude, longitude and altitude, or may be a wireless-based sensor that measures a position based on wireless signals to be sent and received with a wireless access point. Position data generated by the sensor 203 can be collected by the server apparatus 100, for the selection of the associated user and the determination of the weight. The sensor 203 may include other types of sensors such as an electronic compass and an acceleration sensor.

(3) Input Device

The input device 205 is a device that a user uses for operating the terminal apparatus 200, or inputting information to the terminal apparatus 200. The input device 205 can include a touch sensor, a button, a switch, or a keypad, for example. The input device 205 may include a voice input module that detects a voice command given by a user as a user input. In the case where the terminal apparatus 200 is a wearable apparatus that includes an HMD, the input device 205 may include an eye-gaze detection module that detects an eye gaze of a user as a user input.

(4) Communication I/F

The communication I/F 207 is a communication interface that supports an arbitrary wireless communication protocol (for example, W-CDMA, WiMAX, LTE, LTE-A or wireless LAN) or wire communication protocol. The communication I/F 207 establishes a communication connection between the terminal apparatus 200 and the server apparatus 100. The communication I/F 207 may support a neighborhood-terminal detection function based on, for example, wireless LAN or Bluetooth (R).

(5) Memory

The memory 209 is constituted by a storage medium such as a semiconductor memory or a hard disk, and stores programs and data for processing by the terminal apparatus 200. Here, a part or a whole of programs and data to be described in this section may be acquired from an external data source (for example, a data server, a network storage, or an external memory), without being stored in the memory 209.

(6) Display

The display 211 includes a screen constituted by an LCD, an OLED or the like, and displays images. For example, the screen of the display 211 can display an application image for showing a recommendation result, and GUI images.

(7) Microphone

The microphone 213 is a voice input interface that collects voice given from a user or at the neighborhood of a user. For example, in order to select the associated user, the microphone 213 may collect voice of a user who is at the neighborhood of the target user.

(8) Bus

The bus 217 mutually connects the camera 201, the sensor 203, the input device 205, the communication I/F 207, the memory 209, the display 211, the microphone 213 and the processor 219.

(9) Processor

The processor 219 may be a CPU or a DSP, for example. The processor 219 executes the programs stored in the memory 209 or other storage media, and thereby activates various functions of the terminal apparatus 200, which will be described later.

[3-2. Exemplary Functional Configuration]

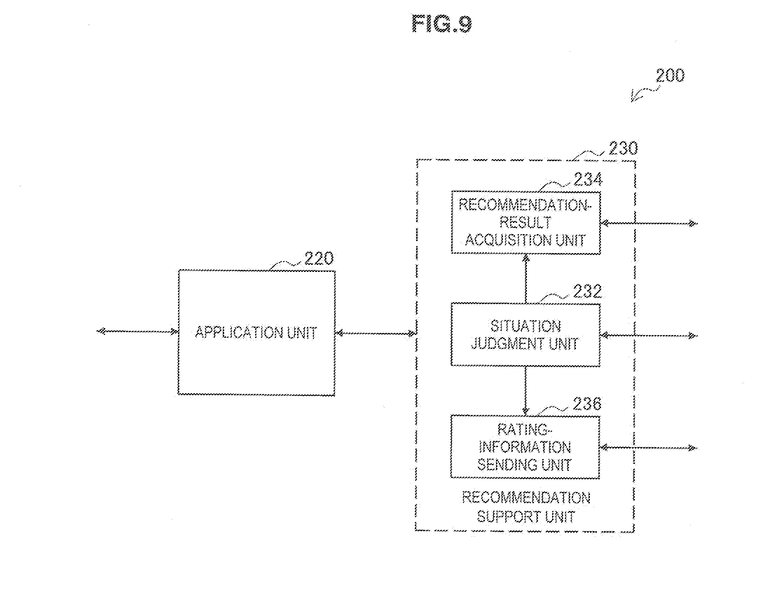

FIG. 9 is a block diagram showing an exemplary configuration of logical functions that are implemented in the memory 209 and processor 219 of the terminal apparatus 200 shown in FIG. 8. With reference to FIG. 9, the terminal apparatus 200 includes an application unit 220 and a recommendation support unit 230. The recommendation support unit 230 includes a situation judgment unit 232, a recommendation-result acquisition unit 234 and a rating-information sending unit 236.

(1) Application Unit

The application unit 220 executes various applications that the terminal apparatus 200 has. The applications to be executed by the application unit 220 may be any kind of applications, such as an internet browser, a content player, an SNS client, an instant messenger, a VoIP client, a mailer, a television tuner, and an electronic book reader.

When an active application has a recommendation-result display function, the application unit 220 sends a recommendation request from the recommendation-result acquisition unit 234 to the server apparatus 100. Then, the application unit 220 displays the information about a recommended item on the screen, in accordance with a recommendation result that the recommendation-result acquisition unit 234 receives from the server apparatus 100.

(2) Situation Judgment Unit

The situation judgment unit 232 judges the communication situation and action of a user with the terminal apparatus 200. For example, in the case where the user with the terminal apparatus 200 is the target user, the situation judgment unit 232 may judge the communication situation of the target user and generate communication situation data in which the judged communication situation is described. The communication situation data can be generated from logs in an SNS or other services, for example. The communication situation data can contain, for example, login information to a social network for the target user, identification information in a community, and information relevant to a communication partner (for example, a user ID, communication time and communication frequency). The situation judgment unit 232 outputs the communication situation data generated in this way, to the recommendation-result acquisition unit 234. The situation judgment unit 232 may call the neighborhood-terminal detection function of the terminal apparatus 200, and outputs a user ID list of users with the detected neighborhood terminals, to the recommendation-result acquisition unit 234.

For example, in the case where the user with the terminal apparatus 200 is the associated user, the situation judgment unit 232 may judge an action of the associated user for an item, from operation logs in an application recorded in the application unit 220. The situation judgment unit 232 can judge, as the action of the associated user, a start and end of viewing and listening of a video content or music content, a browsing or purchasing of a product at an online store, or a browsing of a news article, for example. The situation judgment unit 232 may judge the action of the associated user, using a pickup image from the camera 201, sensor data from the sensor 203, or a voice inputted from the microphone 213, instead of operation logs in an application. The situation judgment unit 232 outputs a judgment result about such an action of the associated user, to the rating-information sending unit 236.

(3) Recommendation-Result Acquisition Unit

The recommendation-result acquisition unit 234 sends a recommendation request to the server apparatus 100, and receives a recommendation result from the server apparatus 100. The recommendation request can contain, in addition to the user ID of the target user, at least one of the position data of the target user, the communication situation data and a user ID list of associated user candidates. The associated user candidate may be a user with the neighborhood terminal, or may be a user who the target user designates through the GUI. Also, the recommendation request may contain the identifier of the selection criterion that is a criterion for selecting the associated user and that the target user can designate through the GUI. The recommendation-result acquisition unit 234, once receiving the recommendation result that the server apparatus 100 sends in response to the recommendation request, outputs the recommendation result to the application unit 220.

In the case where the target user has moved after the recommendation request was once sent to the server apparatus 100, the recommendation-result acquisition unit 234 may send the position data of the target user to the server apparatus 100, again. Also, in the case where the communication situation of the target user has changed, the recommendation-result acquisition unit 234 may send the communication situation data of the target user to the server apparatus 100, again. In addition, in the case where the associated user candidate has changed, the recommendation-result acquisition unit 234 may send the user ID list of associated user candidates to the server apparatus 100, again. Such data sending may be performed periodically.

(4) Rating-Information Sending Unit

The rating-information sending unit 236 sends the above-described rating information to the server apparatus 100. The rating-information sending unit 236 may generate the rating information, based on the judgment result for the action of the associated user, which is inputted from the situation judgment unit 232. The rating information can contain the action history of the associated user, or the rating value determined based on the action history. Alternatively, the rating-information sending unit 236 may generate the rating information containing the rating value that the associated user designates through the GUI.

(5) Recommendation Score Switching

As an example, the recommendation-result acquisition unit 234 may provide, to the target user, a user interface for switching the recommendation score that is the basis of the recommendation result, between the basic recommendation score and the after-correction recommendation score.

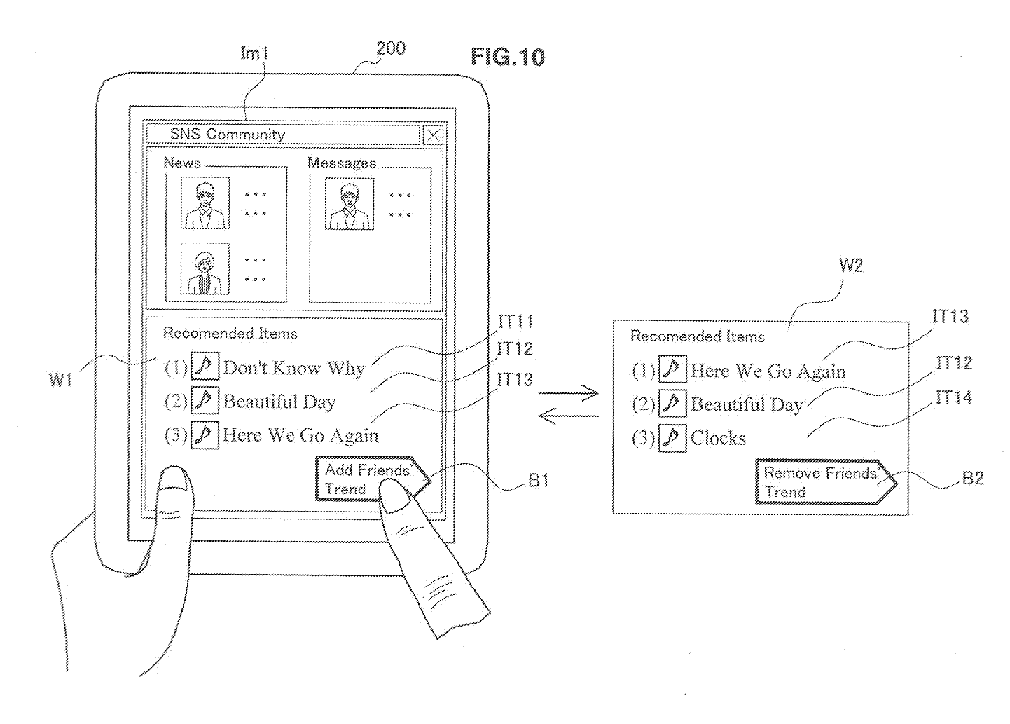

FIG. 10 is an explanatory diagram for explaining a switching of the recommendation score. With reference to the left side of FIG. 10, an application image 1 ml is displayed on the screen of the terminal apparatus 200. The lower half of the application image 1 ml is a recommendation-result display region W1. The recommendation result shown in the recommendation-result display region W1 is a result based on the basic recommendation score. In the example of FIG. 10, the recommended item is a music content, and as a recommendation result, the titles of three recommended items IT11, IT12 and IT13 are displayed in the recommendation-result display region W1, in descending order of the basic recommendation score. The recommendation-result display region W1 contains a button B1. Once the target user taps the button B1, the recommendation score that is the basis of the recommendation result is switched to the after-correction recommendation score.

With reference to the right side of FIG. 10, a recommendation-result display region W2 is displayed, as an example of display after tapping the button B1. The recommendation result shown in the recommendation-result display region W2 is a result based on the after-correction recommendation score. In the recommendation-result display region W2, as a recommendation result, the titles of three recommended items IT13, IT12 and IT14 are displayed in descending order of the after-correction recommendation score. The recommendation-result display region W2 contains a button B2 for switching the recommendation score that is the basis of the recommendation result to the basic recommendation score.

By switching the recommendation score through such a user interface as shown in FIG. 10, the target user can know how the recommendation result changes when incorporating the factor of word-of-mouth communication from his or her friends or other associated users.

[3-3. Modifications]

Some of the functions of the server apparatus 100 described using FIG. 3 are mounted in the terminal apparatus 200. For example, the terminal apparatus 200 may have the function of the recommendation unit 120, and select the recommended item based on the after-correction recommendation score S_{C} that is received from the server apparatus 100. The terminal apparatus 200 may have the function of the associated-user selection unit 140, and select the associated user in accordance with any one of the above-described first to fourth criteria (or other selection criteria). The terminal apparatus 200 may have the function of the correction-score determination unit 154, and determine the weight of each associated user based on the communication situation of the target user or the position data of the target user and associated user, to inform the server apparatus 100 of the determined weight. The terminal apparatus 200 may calculate the correction recommendation score for each item from the product of the determined weight and the rating value, and inform the server apparatus 100 of the calculated correction recommendation score. The terminal apparatus 200 may have the function of the score correction unit 156, and generate the after-correction recommendation score by correcting the basic recommendation score using the correction recommendation score.

### 4. Exemplary Recommendation Scenario

In this section, there will be described exemplary recommendation scenarios that are implemented using the above-described server apparatus 100 and terminal apparatus 200.

[4-1. First Scenario]

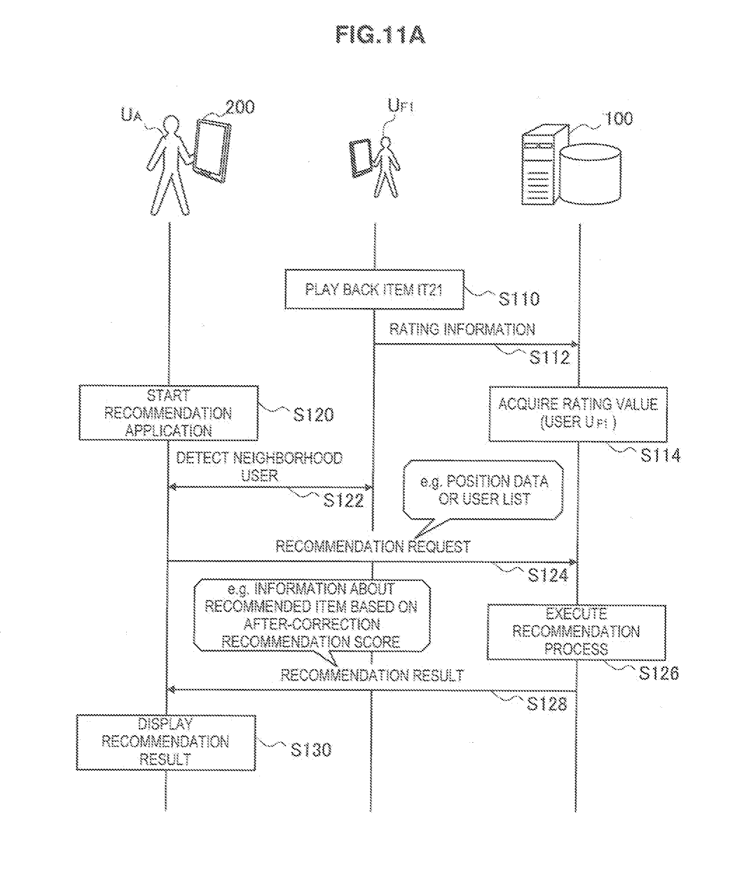

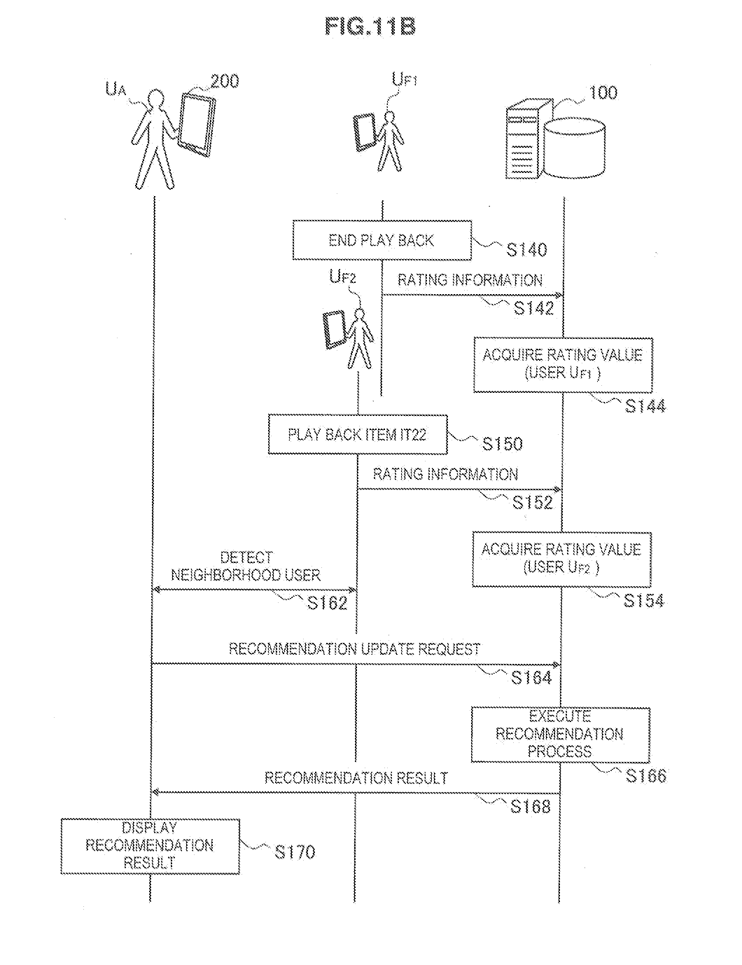

FIG. 11A and FIG. 11B are sequence diagrams for explaining a first example of a recommendation scenario. In the first example, the user U_{A} is the target user, and the user U_{F1} and user U_{F2} are the associated users.

With reference to FIG. 11A, first, the user U_{F1} starts a playback of an item IT21 (for example, a video content, a music content or a picture content) in the terminal apparatus 200 (step S110). In response to the playback start of the item IT21, the terminal apparatus 200 of the user U_{F1} generates rating information, and sends the generated rating information to the server apparatus 100 (step S112). The server apparatus 100 acquires a rating value for the user U_{F1} from the received rating information (step S114).

Next, the user U_{A} starts an application having a recommendation-result display function, on the terminal apparatus 200 (step S120). For example, the terminal apparatus 200 of the user U_{A} calls a neighborhood-terminal detection function, and detects neighborhood users who are at its own neighborhood (step S122). Then, the terminal apparatus 200 of the user U_{A} sends a recommendation request to the server apparatus 100 (step S124). The recommendation request to be sent at this time can contain, for example, the position data of the user U_{A} and a list of the user IDs of the neighborhood users (associated user candidates), in addition to the user ID of the user U_{A} who is the target user.

Next, the server apparatus 100, once receiving the recommendation request, executes the recommendation process described using FIG. 7 (step S126). More concretely, for example, the server apparatus 100 determines the basic recommendation score for the user U_{A}. Furthermore, the server apparatus 100 selects the user U_{F1} as an associated user, using the data that is contained in the recommendation request. Next, the server apparatus 100 determines the correction recommendation score, using the weight and rating value for the user U_{F1} who is an associated user. In the example of FIG. 11A, since the user U_{F1} is the only associated user, the weight of the user U_{F1} may be 1.0. The rating value for the user U_{F1} has been already acquired in step S114. Then, the server apparatus 100 calculates the after-correction recommendation score, by correcting the basic recommendation score using the correction recommendation score. Furthermore, the server apparatus 100 selects recommended items based on the calculated after-correction recommendation score. Then, the server apparatus 100 sends a recommendation result to the terminal apparatus 200 of the user U_{A} (step S128). The recommendation result to be sent at this time can contain, for example, the information about one or more recommendation items that are selected based on the after-correction recommendation score.

Next, the terminal apparatus 200 of the user U_{A}, once receiving the recommendation result from the server apparatus 100, displays the information about the recommended items on the screen, in accordance with the received recommendation result (step S130). In the example of FIG. 11A, the item IT21 that the associated user U_{F1} is playing back, can be presented to the target user U_{A} as an item having a high recommendation score.

Next, with reference to FIG. 11B, the user U_{F1} ends the playback of the item IT21 (step S140). In response to the playback end of the item IT21, the terminal apparatus 200 of the user U_{F1} generates rating information, and sends the generated rating information to the server apparatus 100 (step S142). The server apparatus 100 acquires a new rating value for the user U_{F1} from the received rating information (step S144).

Next, the user U_{F2} comes close to the user U_{A}, and starts a playback of an item IT22 in the terminal apparatus 200 of the user U_{F2} (step S150). In response to the playback start of the item IT22, the terminal apparatus 200 of the user U_{F2} generates rating information, and sends the generated rating information to the server apparatus 100 (step S152). The server apparatus 100 acquires a rating value for the user U_{F2} from the received rating information (step S154).

The terminal apparatus 200 of the user U_{A}, for example, periodically executes the neighborhood-terminal detection function, and detects the user U_{F2} who is a neighborhood user at its own neighborhood (step S162). Then, the terminal apparatus 200 of the user U_{A} sends a recommendation update request to the server apparatus 100 (step S164). The recommendation update request to be sent at this time can contain, for example, the latest position data of the user U_{A} and a list of the user IDs of the neighborhood users in which the user IDs of the users U_{F1} and U_{F2} are described.

Next, the server apparatus 100, once receiving the recommendation update request, executes the recommendation process, again (step S166). Unlike the recommendation process in step S126, two persons, the users U_{F1} and U_{F2} are associated users in step S166. The rating value for the user U_{F1} has been already acquired in step S144. The rating value for the user U_{F2} has been already acquired in step S154. The rating value for the user U_{F1} that has been acquired at an earlier time, may be attenuated with time. The server apparatus 100 corrects the basic recommendation score using the correction recommendation score that is determined from these rating values, and selects recommended items based on the after-correction recommendation score. Then, the server apparatus 100 sends a recommendation result to the terminal apparatus 200 of the user U_{A} (step S168).

Next, the terminal apparatus 200 of the user U_{A}, once receiving the recommendation result from the server apparatus 100, updates the information about the recommended items on the screen, in accordance with the received recommendation result (step S170). In the example of FIG. 11B, the item IT22 that is being played back by the associated user U_{F2}, can be presented to the target user U_{A} as an item having a high recommendation score, instead of the item IT21 in which the playback by the associated user U_{F1} has ended.

[4-2. Second Scenario]

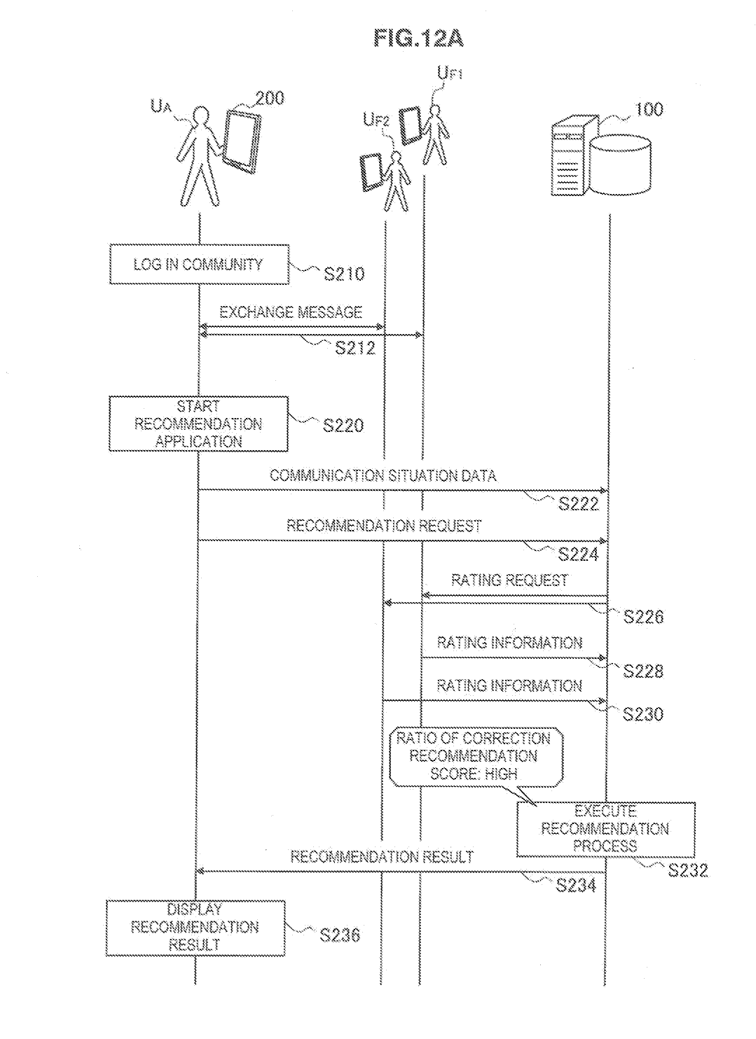

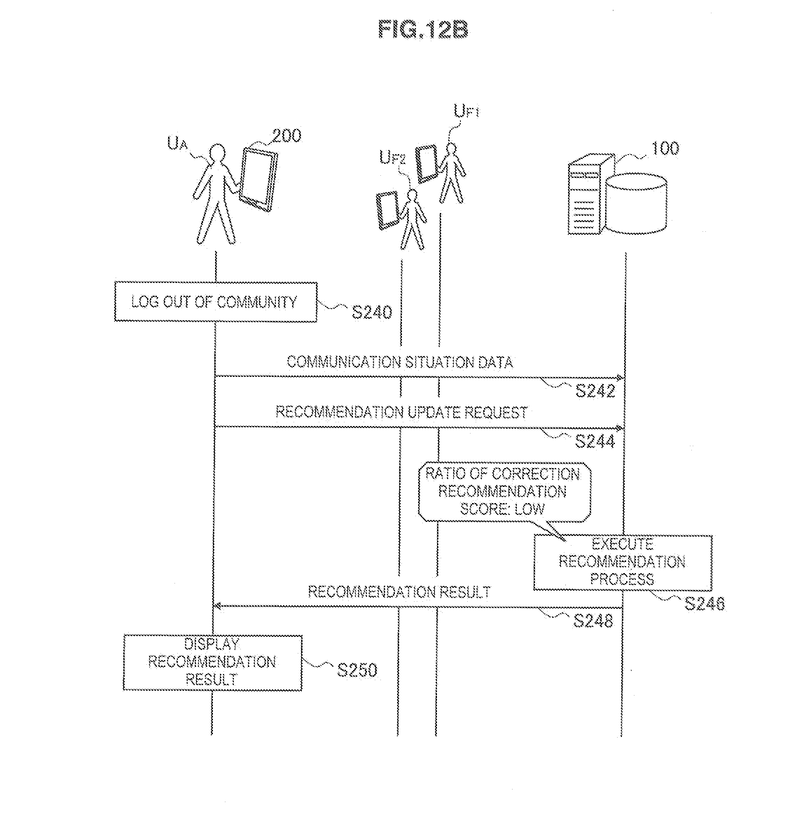

FIG. 12A and FIG. 12B are sequence diagrams for explaining a second example of a recommendation scenario. In the second example, also, the user U_{A} is the target user, and the user U_{F1} and user U_{F2} are the associated users.

With reference to FIG. 12A, first, the user U_{A} logs in an SNS community with the terminal apparatus 200 (step S210). Then, the user U_{A} exchanges messages with the user U_{F1} and user U_{F2} in the logged-in community (step S212).

Next, the user U_{A} starts an application having a recommendation-result display function, on the terminal apparatus 200 (step S220). For example, the terminal apparatus 200 of the user U_{A} generates communication situation data, and sends the generated communication situation data to the server apparatus 100 (step S222). Also, the terminal apparatus 200 of the user U_{A} sends a recommendation request to the server apparatus 100 (step S224). Here, the communication situation data may be contained in the recommendation request, instead of being sent separately from the recommendation request.

Next, the server apparatus 100, once receiving the recommendation request, sends a rating request to each of the terminal apparatuses 200 of the user U_{F1} and user U_{F2} who are selected as associated users (step S226). The terminal apparatus 200 of the user U_{F1} sends rating information to the server apparatus 100, in response to the rating request (step S228). Similarly, the terminal apparatus 200 of the user U_{F2} sends rating information to the server apparatus 100, in response to the rating request (step S230). Then, the server apparatus 100 executes the recommendation process described using FIG. 7 (step S232). In the example of FIG. 12A, since the user U_{A} participates in a specific community, the server apparatus 100 can use a higher synthesis ratio when correcting the basic recommendation score using the correction recommendation score. Then, the server apparatus 100 sends a recommendation result to the terminal apparatus 200 of the user U_{A} (step S234).

Next, the terminal apparatus 200 of the user U_{A}, once receiving the recommendation result from the server apparatus 100, displays the information about the recommended items on the screen, in accordance with the received recommendation result (step S236). In the example of FIG. 12A, items that the associated user U_{F1} and associated user U_{F2} are interested in, can be presented to the target user U_{A} as items having high recommendation scores.

Next, with reference to FIG. 12B, the user U_{A} logs out of the SNS community with the terminal apparatus 200 (step S240). Next, the terminal apparatus 200 of the user U_{A} generates communication situation data again, and sends the generated communication situation data to the server apparatus 100 (step S242). The communication situation data to be generated at this time shows that the user U_{A} has logged out of the community. Next, the terminal apparatus 200 of the user U_{A} sends a recommendation update request to the server apparatus 100 (step S244). Here, the communication situation data may be contained in the recommendation update request, instead of being sent separately from the recommendation update request.

Next, the server apparatus 100, once receiving the recommendation update request, executes the recommendation process, again (step S246). Unlike the recommendation process in step S232, since the user U_{A} does not participate in the community in step S246, the server apparatus 100 can use a lower synthesis ratio. Then, the server apparatus 100 sends a recommendation result to the terminal apparatus 200 of the user U_{A} (step S248).

Next, the terminal apparatus 200 of the user U_{A}, once receiving the recommendation result from the server apparatus 100, updates the information about the recommended items on the screen, in accordance with the received recommendation result (step S250). In the example of FIG. 12B, there is increased a possibility that the recommendation scores of the items that that the associated user U_{F1} and associated user U_{F2} are interested in become lower compared to the recommendation scores at the time of step S236, and another item is contained in recommended items.

### 5. Conclusion

Additionally, the present technology may also be configured as below.

(1) An information processing apparatus including:

a recommendation unit configured to generate a recommendation information for a target user based on a preference information of at least one associated person having a social relationship through a communication service or a locational relationship with the target user; and

a communication interface configured to provide the generated recommendation information to be sent to the target user.

(2) The information processing apparatus of (1),

wherein the recommendation information includes at least one of a video, picture, music content, advertising information, and a news article.

(3) The information processing apparatus of (1) or (2), further including:

an associated person selection unit configured to select the at least one associated person.

(4) The information processing apparatus of any of (1) through (3), wherein the associated person selection unit selects the at least one associated person based on a user ID of the target user.
(5) The information processing apparatus of any of (1) through (4), wherein the associated person selection unit selects the at least one associated person such that each one of the at least one associated person is physically located within a predetermined vicinity of the target user.
(6) The information processing apparatus of any of (1) through (5), wherein the associated person selection unit selects the at least one associated person based on a communication status of the target user through the communication service.
(7) The information processing apparatus of any of (1) through (6), wherein the communication status is a frequency of communication between the target user and another user within the communication service.
(8) The information processing apparatus of any of (1) through (7), wherein each one of the at least one associated person is a registered friend of the target user within a social media service.
(9) The information processing apparatus of any of (1) through (8), wherein the recommendation unit generates the recommendation information based on the preference information of the at least one associated person and a preference information of the target user.
(10) The information processing apparatus of any of (1) through (9), wherein the recommendation unit generates the recommendation information based on a detection of a triggering event, the triggering event being at least one of a receipt of a request to update the recommendation information, a detected change in a communication status of the target user, a detected movement of the target user, a detected action made by one of the at least one associated person, and a detected change in a number of the at least one associated person.
(11) The information processing apparatus of any of (1) through (10), wherein the at least one associated person has a social relationship with the target user, and each one of the at least one associated person has previously communicated with the target user within a social media service.
(12) The information processing apparatus of any of (1) through (11), wherein the recommendation unit generates the recommendation information by determining a basic recommendation score for the target user, determining a correction recommendation score based on the preference information of the at least one associated person, correcting the basic recommendation score by using the correction recommendation score, and generating the recommendation information based on the corrected basic recommendation score.
(13) The information processing apparatus of any of (1) through (12), wherein the correction recommendation score is determined by weighting each of the at least one associated person.
(14) The information processing apparatus of any of (1) through (13), wherein the correction recommendation score changes based on a situation of the target user.
(15) An information processing method including:

generating a recommendation information for a target user based on a preference information of at least one associated person having a social relationship through a communication service or a locational relationship with the target user; and

providing the generated recommendation information to be sent to the target user.

(16) A non-transitory computer-readable medium having embodied thereon a program, which when executed by a computer causes the computer to execute a method, the method including:

generating a recommendation information for a target user based on a preference information of at least one associated person having a social relationship through a communication service or a locational relationship with the target user; and

providing the generated recommendation information to be sent to the target user.

(17) A terminal apparatus forming part of a communication system, the communication system also including an information processing apparatus configured to provide recommendation information to the terminal apparatus, the terminal apparatus including:

a circuitry configured to
transmit and receive data signals via a network;
send a request for recommendation information for a user of the terminal apparatus; and
receive the recommendation information which is generated based on a preference information of at least one associated person having a social relationship though a communication service or a locational relationship with the user of the terminal apparatus.
   (18) The terminal apparatus of (17), wherein the request for recommendation information includes a user ID of the user of the terminal apparatus and a candidate of the at least one associated person.
   (19) The terminal apparatus of (17) or (18), further including a display configured to selectively display one of a first display result and a second display result, wherein the first display result is generated based on a preference information of the user of the terminal apparatus without consideration of a preference of the at least one associated person, and the second display result is generated based on both the preference information of the user of the terminal apparatus and the preference of the at least one associated person.
   (20) A method including:

requesting a recommendation information for a target user from a server; and

receiving the recommendation information from the server,

wherein the recommendation information is generated based on a preference information of at least one associated person having a social relationship through a communication service or a locational relationship with the target user.

(21) A non-transitory computer-readable medium having embodied thereon a program, which when executed by a computer causes the computer to execute a method, the method including:

requesting a recommendation information for a target user from a server; and

receiving the recommendation information from a server,

wherein the recommendation information is generated based on a preference information of at least one associated person having a social relationship through a communication service or a locational relationship with the target user.

(22) An information processing apparatus comprising

a score correction unit to correct a basic recommendation score using a correction recommendation score, the basic recommendation score being determined for a user by a recommendation algorithm, the correction recommendation score being determined based on actions of one or more persons who have an association with the user.

(23) The information processing apparatus of (22), further comprising

a selection unit to select the one or more persons for determining the correction recommendation score.

(24) The information processing apparatus of (22) or (23), wherein the selection unit selects the one or more persons, based on a communication situation of the user in a social network.
(25) The information processing apparatus of any of (22) through (24), wherein the selection unit selects the one or more persons who are at a neighborhood of the user.
(26) The information processing apparatus of any of (22) through (25), wherein the selection unit selects the one or more persons, based on a recognition processing of a picture or a voice acquired through an apparatus that the user carries or wears.
(27) The information processing apparatus of any of (22) through (26), wherein the selection unit selects the one or more persons whom the user designates through a user interface.
(28) The information processing apparatus of any of (22) through (27), wherein the selection unit provides a user interface through which the user designates a selection criterion in selection of the one or more persons.
(29) The information processing apparatus of any of (22) through (28), further comprising

a correction-score determination unit to determine the correction recommendation score based on actions of the one or more persons.

(30) The information processing apparatus of any of (22) through (29), wherein the correction-score determination unit calculates the correction recommendation score, using a weight of each person and a rating value acquired for each person.
(31) The information processing apparatus of any of (22) through (30), wherein the weight is determined based on a communication situation or position data of the user, or is designated by the user.
(32) The information processing apparatus of any of (22) through (31), wherein the rating value is determined based on an action history of each of the one or more persons, or is designated by each of the one or more persons.
(33) The information processing apparatus of any of (22) through (32), wherein the rating value is attenuated with time, after the rating value is determined based on an action history of each of the one or more persons.
(34) The information processing apparatus of any of (22) through (33), wherein the score correction unit variably controls a ratio of the correction recommendation score to the basic recommendation score.
(35) The information processing apparatus of any of (22) through (34), wherein the score correction unit increases the ratio of the correction recommendation score to the basic recommendation score, while the user participates in a specific community.
(36) The information processing apparatus of any of (22) through (35), wherein the score correction unit increases the ratio of the correction recommendation score to the basic recommendation score, while the user is in a specific place.
(37) The information processing apparatus of any of (22) through (36), wherein the recommendation algorithm includes at least one of an algorithm based on a preference of a user and an algorithm based on an attribute of an item.
(38) An information processing method to be executed by an information processing apparatus, the method comprising

correcting a basic recommendation score using a correction recommendation score, the basic recommendation score being determined for a user by a recommendation algorithm, the correction recommendation score being determined based on actions of one or more persons who have an association with the user.

(39) A program for causing a computer that controls an information processing apparatus to function as:

a score correction unit to correct a basic recommendation score using a correction recommendation score, the basic recommendation score being determined for a user by a recommendation algorithm, the correction recommendation score being determined based on actions of one or more persons who have an association with the user.

(40) A terminal apparatus comprising:

a communication interface to communicate with a server apparatus that corrects a basic recommendation score using a correction recommendation score, the basic recommendation score being determined for a user by a recommendation algorithm, the correction recommendation score being determined based on actions of one or more persons who have an association with the user; and

a control unit to display information of a recommended item on a screen, in accordance with a recommendation result that is received from the server apparatus through the communication interface,

wherein the control unit sends a list of the one or more persons to the server apparatus, and receives a recommendation result from the server apparatus, the recommendation result being based on the correction recommendation score that is determined using the sent list.

(41) The terminal apparatus of (40),

wherein the correction recommendation score is calculated using a weight of each person and a rating value acquired for each person, and

wherein the control unit informs the sever apparatus of the weight through the communication interface, the weight being determined based on a communication situation or position data of the user, or designated by the user.

(42) A terminal apparatus incorporating a circuitry configured to transmit and receive data signals, the terminal apparatus forming part of a communication system, the communication system also including:
an information processing apparatus comprising:
a recommendation unit configured to generate a recommendation information for a target user based on a preference information of at least one associated person having a social relationship or a locational relationship with the target user; and
a communication interface configured to provide the generated recommendation information to the target user;
wherein when the information processing apparatus receives, from the terminal apparatus, a request for the recommendation information for the target user, the recommendation unit generates the recommendation information and the generated recommendation information is provided to the terminal apparatus through the communication interface.
(43) The terminal apparatus of (42), wherein the information processing apparatus further comprises an associated person selection unit configured to select the at least one associated person.
(44) The terminal apparatus of (42) or (43) wherein the associated person selection unit selects the at least one associated person based on a user ID of the target user.
(45) The terminal apparatus of any of (42) through (44), wherein the associated person selection unit selects the at least one associated person such that each one of the at least one associated person is physically located within a predetermined vicinity of the target user.
(46) The terminal apparatus of any of (42) through (45), wherein the associated person selection unit selects the at least one associated person based on a communication status of the target user.
(47) The terminal apparatus of any of (42) through (46), wherein the communication status is a frequency of communication between the target user and respective ones of the at least one associated person.
(48) The terminal apparatus of any of (42) through (47), wherein each one of the at least one associated person is a registered friend of the target user within a social media service.
(49) The terminal apparatus of any of (42) through (48), wherein the recommendation unit generates the recommendation information based on the preference information of the at least one associated person and a preference information of the target user.
(50) The terminal apparatus of any of (42) through (49), wherein the recommendation unit generates the recommendation information based on a detection of a triggering event, the triggering event being at least one of a receipt of a request to update the recommendation information, a detected change in a communication status of the target user, a detected movement of the target user, a detected action made by one of the at least one associated person, and a detected change in a number of the at least one associated person.
(51) The terminal apparatus of any of (42) through (50), wherein the at least one associated person has a social relationship with the target user, and each one of the at least one associated person has previously communicated with the target user within a social media service.
(52) The terminal apparatus of any of (42) through (51), wherein the recommendation unit generates the recommendation information by determining a basic recommendation score for the target user, determining a correction recommendation score based on the preference information of the at least one associated person, correcting the basic recommendation score by using the correction recommendation score, and generating the recommendation information based on the corrected basic recommendation score.

What is claimed is:

1. An information processing apparatus comprising:
a recommendation unit configured to generate a recommendation information for a target user based on a preference information of at least one associated person having a social relationship through a communication service or a locational relationship with the target user; and
a communication interface configured to provide the generated recommendation information to be sent to the target user.

2. The information processing apparatus of claim 1,
wherein the recommendation information comprises at least one of a video, picture, music content, advertising information, and a news article.

3. The information processing apparatus of claim 1, further comprising:
an associated person selection unit configured to select the at least one associated person.

4. The information processing apparatus of claim 3, wherein the associated person selection unit selects the at least one associated person based on a user ID of the target user.

5. The information processing apparatus of claim 3, wherein the associated person selection unit selects the at least one associated person such that each one of the at least one associated person is physically located within a predetermined vicinity of the target user.

6. The information processing apparatus of claim 3, wherein the associated person selection unit selects the at least one associated person based on a communication status of the target user through the communication service.

7. The information processing apparatus of claim 6, wherein the communication status is a frequency of communication between the target user and another user within the communication service.

8. The information processing apparatus of claim 3, wherein each one of the at least one associated person is a registered friend of the target user within a social media service.

9. The information processing apparatus of claim 1, wherein the recommendation unit generates the recommendation information based on the preference information of the at least one associated person and a preference information of the target user.

10. The information processing apparatus of claim 1, wherein the recommendation unit generates the recommendation information based on a detection of a triggering event, the triggering event being at least one of a receipt of a request to update the recommendation information, a detected change in a communication status of the target user, a detected movement of the target user, a detected action made by one of the at least one associated person, and a detected change in a number of the at least one associated person.

11. The information processing apparatus of claim 1, wherein the at least one associated person has a social relationship with the target user, and each one of the at least one associated person has previously communicated with the target user within a social media service.

12. The information processing apparatus of claim 1, wherein the recommendation unit generates the recommendation information by determining a basic recommendation score for the target user, determining a correction recommendation score based on the preference information of the at least one associated person, correcting the basic recommendation score by using the correction recommendation score, and generating the recommendation information based on the corrected basic recommendation score.

13. The information processing apparatus of claim 12, wherein the correction recommendation score is determined by weighting each of the at least one associated person.

14. The information processing apparatus of claim 13, wherein the correction recommendation score changes based on a situation of the target user.

15. An information processing method comprising:
generating a recommendation information for a target user based on a preference information of at least one associated person having a social relationship through a communication service or a locational relationship with the target user; and
providing the generated recommendation information to be sent to the target user.

16. A non-transitory computer-readable medium having embodied thereon a program, which when executed by a computer causes the computer to execute a method, the method comprising:
generating a recommendation information for a target user based on a preference information of at least one associated person having a social relationship through a communication service or a locational relationship with the target user; and
providing the generated recommendation information to be sent to the target user.

17. A terminal apparatus forming part of a communication system, the communication system also including an information processing apparatus configured to provide recommendation information to the terminal apparatus, the terminal apparatus comprising:
a circuitry configured to
transmit and receive data signals via a network;
send a request for recommendation information for a user of the terminal apparatus; and
receive the recommendation information which is generated based on a preference information of at least one associated person having a social relationship though a communication service or a locational relationship with the user of the terminal apparatus.

18. The terminal apparatus of claim 17, wherein the request for recommendation information includes a user ID of the user of the terminal apparatus and a candidate of the at least one associated person.

19. The terminal apparatus of claim 17, further comprising a display configured to selectively display one of a first display result and a second display result, wherein the first display result is generated based on a preference information of the user of the terminal apparatus without consideration of a preference of the at least one associated person, and the second display result is generated based on both the preference information of the user of the terminal apparatus and the preference of the at least one associated person.

20. A method comprising:
requesting a recommendation information for a target user from a server; and
receiving the recommendation information from the server,
wherein the recommendation information is generated based on a preference information of at least one associated person having a social relationship through a communication service or a locational relationship with the target user.

21. A non-transitory computer-readable medium having embodied thereon a program, which when executed by a computer causes the computer to execute a method, the method comprising:
requesting a recommendation information for a target user from a server; and
receiving the recommendation information from a server,
wherein the recommendation information is generated based on a preference information of at least one associated person having a social relationship through a communication service or a locational relationship with the target user.
